(19) United States
(12) Patent Application Publication
(10) Pub. No.: US 2020/0148080 A1
(43) Pub. Date: May 14, 2020

(54) SEAT FOR A VEHICLE PROVIDING A TEMPERATURE-STABLE, RATE-SENSITIVE SUPPORT

(71) Applicant: GM GLOBAL TECHNOLOGY OPERATIONS LLC, Detroit, MI (US)

(72) Inventors: Edward T. Kuczynski, Bloomfield Hills, MI (US); Daniel W. Booth, Troy, MI (US)

(21) Appl. No.: 16/184,088

(22) Filed: Nov. 8, 2018

(51) Int. Cl. B60N 2/42; A47C 7/20; B60N 2/70

(52) U.S. Cl. CPC B60N 2/4263; B60N 2/4214; B60N 2/70; A47C 7/20

(57) ABSTRACT

A vehicle seat for a vehicle. The vehicle seat includes a first foam and a second foam. The first foam has a rate sensitivity as measured in accordance with a modified ISO 3886/1 standard which can accommodate a slow speed test with a static strain rate of about 0.001 second⁻¹ and a high speed test with a dynamic strain rate of about 100 second⁻¹ such that the dynamic versus static strain rate increases by at least 200%, and the first foam is temperature stable such that the glass transition temperature of the first foam is less than or equal to zero degrees Celsius and a change in tan delta of less than or equal to 35% from a median value measured over a temperature range of from about negative 20 degrees Celsius to about 60 degrees Celsius.

### FIELD

The present disclosure relates to a seat for a vehicle providing a temperature-stable, rate-sensitive support.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Vehicles, such as cars, include vehicle seats. For instance, a vehicle may include several rows of vehicle seats. The vehicle-operator may occupy a vehicle seat in a front row, while passengers may occupy other vehicle seats. Vehicle seats are designed to provide comfortable seating for the vehicle occupants while also providing adequate support for controlling a positioning of the occupants during a vehicle crash event.

In a frontal or rear vehicle crash event, a vehicle occupant has a tendency to “submarine” which means slipping forward in the seat and/or moving downward in the seat in a frontal impact. Alternatively, in a rear impact a vehicle occupant has a tendency to slide upward and backward relative to the seat. In either situation movement of a vehicle seat occupant in the seat is undesirable because vehicle occupant protection systems may rely upon maintaining the vehicle seat occupant in a specific position relative to the seat. For example, if a vehicle seat passenger moves in their vehicle seat during a vehicle impact event, a passenger seat belt system may be unable to adequately control the movement and/or position of the passenger.

Conventional vehicle seats have been designed in an attempt to prevent and/or reduce the submarining of a vehicle seat passenger. For example, a vehicle seat may include a metal (or other rigid material) support structure having a surface which may ramp upwardly in a forward direction positioned underneath a layer of foam. Another exemplary conventional vehicle seat may include a support structure on which a low density, semi-rigid or rigid foam (e.g., expanded Polypropylene, Polyurethane, etc.) is positioned and shaped such that it reduces and/or prevents a vehicle seat occupant from submarining, while also including a more resilient material (e.g., a foam) over the rigid foam and underlying support to improve the comfort of the seat for the vehicle seat occupant. While such conventional vehicle seats may adequately protect a vehicle seat passenger in the event of a vehicle impact event, the comfort of the vehicle passenger may be compromised. It is desirable to improve the comfort of a vehicle seat occupant while continuing to provide adequate support in the event of a vehicle impact event.

### SUMMARY

In an exemplary aspect, a vehicle seat includes a first foam and a second foam. The first foam has a rate sensitivity as measured in accordance with a modified ISO 3886/1 standard which can accommodate a slow speed test with a static strain rate of about 0.001 second⁻¹ and a high speed test with a dynamic strain rate of about 100 second⁻¹ such that the dynamic versus static strain rate increases by at least 200%, and the first foam is temperature stable such that the glass transition temperature of the first foam is less than or equal to zero degrees Celsius and a change in tangent delta of less than or equal to 35% from a median value measured over a temperature range of from about negative 20 degrees Celsius to about 60 degrees Celsius. As is understood by those of ordinary skill in the art, the tangent delta is related to the ability of the foam to dissipate energy during a compression cycle and is related to a recovery time of the foam. The glass transition temperature and tangent delta peak indicate the vitrification of a soft segment phase of the foam. Vitrification manipulates the structure and composition of the soft segment phase so that the glass transition temperature approximately coincides with a use temperature of the foam, thereby maximizing the viscoelastic nature of the foam. The foam has a tangent delta peak at each of the first glass transition temperature and the second glass transition temperature. The ratio of the peak tangent delta is an indicator of the foam's ability to function well at both the first glass transition temperature and the second glass transition temperature. A dynamic mechanical thermal analysis is used to identify tangent delta and the glass transition temperature.

In this manner, the comfort of a vehicle seat occupant across a useful range of temperatures may be ensured while retaining the rate-sensitivity which improves and/or reduces the potential for a vehicle seat occupant to submarine.

In another exemplary aspect, the vehicle seat cushion is positioned in a seat bottom of a vehicle seat and wherein the second foam is vertically oriented relative to the first foam.

In another exemplary aspect, the first foam is positioned in the cushion forward of a hip point.

In another exemplary aspect, the first foam increases in thickness in the cushion in a forward direction.

In another exemplary aspect, a top surface of the first foam inclines upwardly in a forward direction of the vehicle seat.

In another exemplary aspect, a top surface of the first foam inclines upwardly in a forward direction of the vehicle seat.

In another exemplary aspect, the first foam is vertically oriented above the second foam.

In another exemplary aspect, the first foam comprises a plurality of vertically oriented columns.

In another exemplary aspect, each of the plurality of vertically oriented columns is angled rearwardly in the upward direction.

In another exemplary aspect, the vehicle seat cushion is positioned in a seat back of a vehicle seat and wherein the second foam is longitudinally oriented relative to the first foam.

In another exemplary aspect, the first foam increases in thickness in the cushion in an upward direction.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic, cross-sectional side elevation view of a conventional vehicle seat and occupant in a submarine position during a vehicle impact event;

FIG. 2 is a schematic, cross-sectional side elevation view of an exemplary embodiment of a vehicle seat in accordance with the present application and occupant during a vehicle impact event;

FIG. 3 is a schematic, cross-sectional side elevation view of the exemplary embodiment of a vehicle seat of FIG. 2;

FIG. 4 is a schematic, cross-sectional side elevation view of another exemplary embodiment of a vehicle seat and occupant in accordance with the present application;

FIG. 5 is a schematic, cross-sectional side elevation view of an exemplary embodiment of a vehicle seat and occupant in accordance with the present application;

FIG. 6 is a schematic, cross-sectional side elevation view of the vehicle seat and occupant of FIG. 5 during a vehicle impact event;

FIG. 7 is an elevational side view of another exemplary vehicle seat in accordance with the present invention; and

FIG. 8 is an elevational side view of the exemplary vehicle seat in a rear vehicle impact condition.

### DETAILED DESCRIPTION

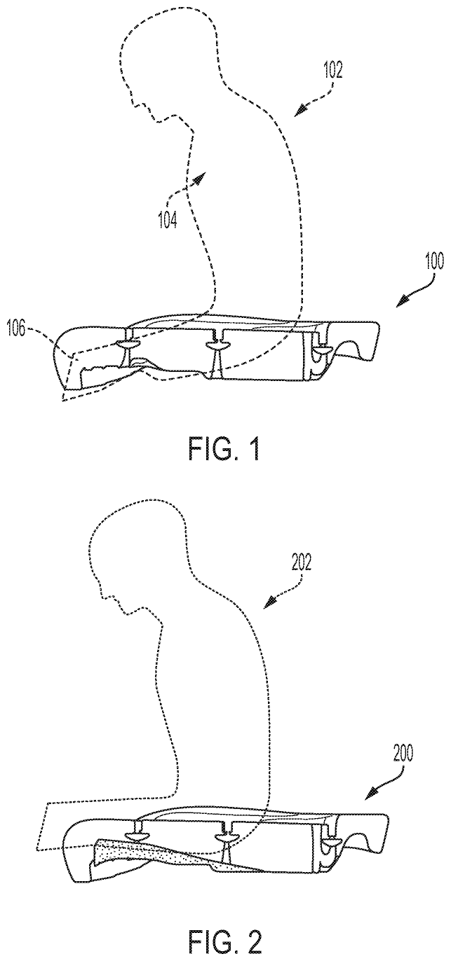

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures, FIG. 1 is a schematic, cross-sectional side elevation view of a conventional vehicle seat 100 and occupant 102 in a submarine position during a vehicle impact event and FIG. 2 is a schematic, cross-sectional side elevation view of an exemplary embodiment of a vehicle seat 200 in accordance with the present application and occupant 202 during a vehicle impact event. FIG. 1 clearly illustrates the undesirable situation in which a vehicle seat 100 is unable to prevent and/or reduce the submarining of the vehicle seat occupant 102. The vehicle seat occupant 102 has moved forward in the seat and the upper torso 104 has rotated forward and downward and the knee 106 of the occupant 102 has also rotated forward and downward. As explained previously, movement of a vehicle occupant in a vehicle seat is undesirable as the ability of vehicle systems to protect the vehicle occupant during an impact event may be reduced.

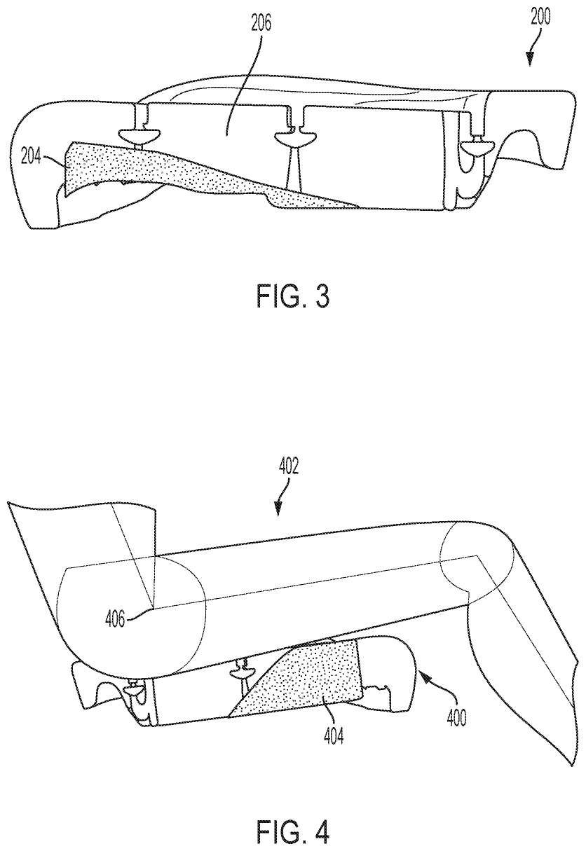

FIG. 3 is a schematic, cross-sectional side elevation view of the exemplary embodiment of a vehicle seat 200 of FIG. 2. The vehicle seat 200 includes a first foam portion 204 and a second foam portion 206. The first foam portion 204 is characterized by a foam that is thermally-stable and rate-sensitive and is shaped and positioned within the vehicle seat in a manner that prevents and/or reduces the potential for an occupant of the vehicle seat 200 to submarine during a vehicle impact event. The second foam portion 206 is characterized by a foam with a resiliency that is comfortable to a vehicle seat occupant and which also may include the capacity to fully return the seat to a desired unloaded shape when an occupant is no longer occupying the vehicle seat 200.

The inventors discovered that recent developments in rate-sensitive foams have resulted in foams that are not only rate-sensitive, but also are thermally stable such that they maintain a desired level of rate-sensitivity across a range of temperatures that may be experienced in a passenger cabin of a vehicle. As a result of this discovery, the inventors have realized that these new foams may be useful to improve the comfort of a vehicle seat occupant across a useful range of temperatures while retaining the rate-sensitivity which improves and/or reduces the potential for a vehicle seat occupant to submarine.

Preferably, an exemplary embodiment of the first foam would have a compression force deflection (CFD) of between about 3.5 Kilopascals to 35 Kilopascals measured according to the ISO 3886/1 standard which tests compression of the foam to 40% compression instantaneously at a temperature of about 23 degrees Celsius and at a relative humidity of about 50%. This characteristic ensures that the first foam is able to provide a desired amount of comfort for an occupant of the vehicle seat.

Further, preferably, the first foam would be temperature stable. The glass transition temperature (Tg) is preferably less than or equal to zero degrees Celsius and a change in tan delta of less than or equal to 35% from a median value measured over a temperature range of from about negative 20 degrees Celsius to about 60 degrees Celsius.

Further, preferably, the rate-sensitivity of the first foam as measured in accordance with a modified ISO 3886/1 standard which can accommodate a slow speed test with a static strain rate of about 0.001 second⁻¹ and a high speed test with a dynamic strain rate of about 100 second⁻¹ such that the dynamic versus static strain rate increases by at least 200%. Preferably, the increase is more than 400% and, more preferably, greater than 1500%.

In this manner, a first foam having characteristics falling within the above-described rate-sensitivity, thermal stability, and compressive force deflection ranges provide the ability for a vehicle seat to reduce and/or prevent vehicle seat occupant submarining during a vehicle impact event, while also not adversely affecting the comfort of the vehicle seat occupant. In other words, the first foam is relatively soft during normal operations under normal passenger cabin temperatures but is hard enough during a vehicle impact to provide an improvement in the ability to reduce and/or prevent vehicle occupant submarining.

The vehicle seat 200 further includes a second foam 206 (or other resilient material) which is layered vertically relative to the first foam 204. The second foam 206 improves the comfort of the vehicle seat occupant while also improving the ability of the seat to return to a desired shape when an occupant no longer occupies the vehicle seat. While the second foam 206 is illustrated in FIG. 3 to be vertically positioned above the first foam 204, it is to be understood that the relative vertical positioning may be reversed from what is illustrated in FIG. 3, or the first foam and second foam may comprise a plurality of vertically arranged layers without limitation.

The first foam 204 in FIG. 3 is also configured in a wedge shape such that the layer of foam 204 is thicker at the forward end than toward the rearward end of the vehicle seat. In this manner, the wedge shape first foam 204 may form a ramp which improves the ability to reduce and/or prevent the vehicle seat occupant from submarining.

In order to provide the ability of the first foam 204 to reduce and/or minimize the submarining of a vehicle seat occupant, at least a portion of the first foam 204 should preferably be positioned forward of a hip point. For example, FIG. 4 illustrates another exemplary embodiment of a vehicle seat 400 in accordance with the present invention. FIG. 4 illustrates an exemplary desired position of an occupant 402 in the vehicle seat. In this exemplary embodiment, the first foam 404 may preferably be positioned forward of a hip-point 406 of the vehicle seat occupant.

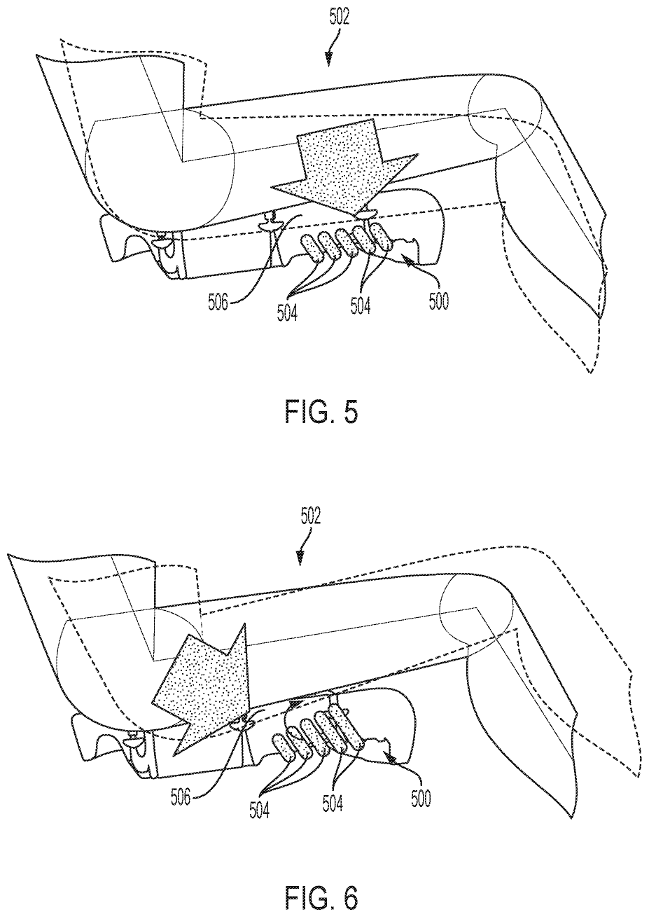

FIGS. 5 and 6 illustrate schematic, cross-sectional side elevation views of another exemplary embodiment of a vehicle seat 500 and occupant 502 in accordance with the present application. The vehicle seat 500 includes a plurality of columns 504 of a first foam embedded within a second foam 506. Preferably, the columns of first foam 504 may be angled rearwardly in the upward direction. In this manner, as illustrated in FIG. 5, under normal operating conditions (i.e. non-impact conditions) the columns of first foam 504 may deflect comfortably in response to downward pressure from the occupant 502 sitting on the vehicle seat 500. In contrast, as illustrated in FIG. 6, under an impact condition, as the momentum of the vehicle seat occupant applies a high force in a forward and downward direction the upward and rearward angle of the columns of first foam 504 reduce and/or prevent the vehicle seat occupant from submarining.

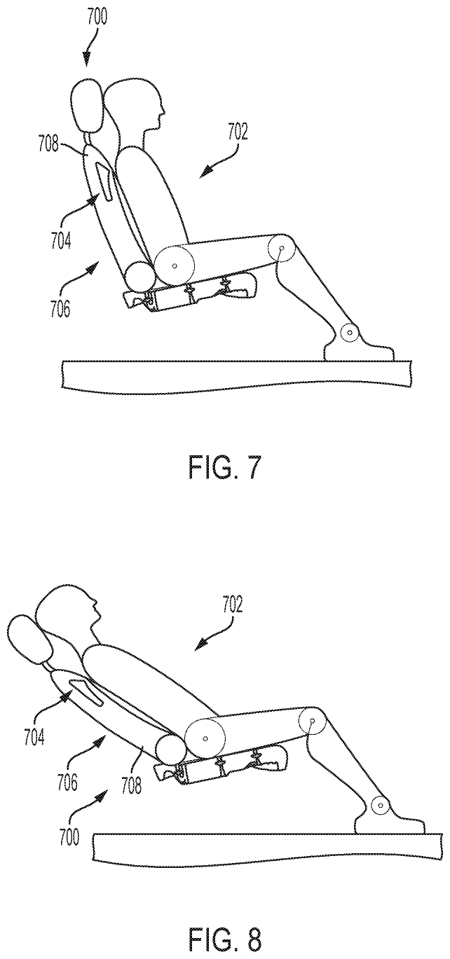

FIG. 7 is an elevational side view of another exemplary vehicle seat 700 in accordance with the present invention with a vehicle occupant 702 occupying the vehicle seat 700. The vehicle seat 700 includes a vehicle seat back 706 with a first foam portion 704 and a second foam portion 708. The first foam portion 704 is characterized by a foam that is thermally-stable and rate-sensitive and is shaped and positioned within the vehicle seat back 706 in a manner that prevents and/or reduces the potential for an occupant 702 of the vehicle seat 700 to sliding upward relative to the seat 700 during a vehicle rear impact event. The second foam portion 708 is characterized by a foam with a resiliency that is comfortable to a vehicle seat occupant and which also may include the capacity to fully return the seat to a desired unloaded shape when an occupant is no longer occupying the vehicle seat 700.

The first foam portion 704 is configured in a wedge shape such that the first form portion 704 is thicker at an upper end than toward a lower end of the vehicle seat back 706. In this manner, the wedge shape of the first foam portion 704 may form a ramp which improves the ability to reduce and/or prevent the vehicle seat occupant from moving upwardly relative to the vehicle seat 700. It is also to be understood that another exemplary embodiment of the vehicle seat may include a first foam portion in a vehicle seat back that includes a plurality of columns embedded within the second foam portion in a manner similar to that illustrated and described with respect to FIGS. 5 and 6. Preferably, the columns of first foam may be angled downwardly in a forward direction.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle seat cushion for a vehicle, the vehicle seat comprising:
a first foam; and
a second foam vertically oriented relative to the first foam, wherein the rate-sensitivity of the first foam as measured in accordance with a modified ISO 3886/1 standard which can accommodate a slow speed test with a static strain rate of about 0.001 second⁻¹ and a high speed test with a dynamic strain rate of about 100 second⁻¹ such that the dynamic versus static strain rate increases by at least 200%, and wherein the first foam is temperature stable such that the glass transition temperature of the first foam is less than or equal to zero degrees Celsius and a change in tan delta of less than or equal to 35% from a median value measured over a temperature range of from about negative 20 degrees Celsius to about 60 degrees Celsius.

2. The vehicle seat cushion of claim 1, wherein the vehicle seat cushion is positioned in a seat bottom of a vehicle seat and wherein the second foam is vertically oriented relative to the first foam.

3. The vehicle seat cushion of claim 2, wherein the first foam is positioned in the cushion forward of a hip point.

4. The vehicle seat cushion of claim 2, wherein the first foam increases in thickness in the cushion in a forward direction.

5. The vehicle seat cushion of claim 2, wherein a top surface of the first foam inclines upwardly in a forward direction of the vehicle seat.

6. The vehicle seat cushion of claim 2, wherein a top surface of the first foam inclines upwardly in a forward direction of the vehicle seat.

7. The vehicle seat cushion of claim 2, wherein the first foam is vertically oriented above the second foam.

8. The vehicle seat cushion of claim 2, wherein the first foam comprises a plurality of vertically oriented columns.

9. The vehicle seat cushion of claim 8, wherein each of the plurality of vertically oriented columns is angled rearwardly in the upward direction.

10. The vehicle seat cushion of claim 1, wherein the vehicle seat cushion is positioned in a seat back of a vehicle seat and wherein the second foam is longitudinally oriented relative to the first foam.

11. The vehicle seat cushion of claim 10, wherein the first foam increases in thickness in the cushion in an upward direction.

12. A vehicle with a vehicle seat cushion comprising:
a supporting frame anchored to a vehicle body structure;
a first foam connected the supporting frame; and
a second foam connected the supporting frame and vertically oriented relative to the first foam, wherein the rate-sensitivity of the first foam as measured in accordance with the ISO 3886/1 standard which has been modified to accommodate a slow speed test with a static strain rate of about 0.001 second⁻¹ and a high speed test with a dynamic strain rate of about 100 second⁻¹ such that the dynamic versus static strain rate increases by at least 200%, and wherein the first foam is temperature stable such that the glass transition temperature of the first foam is less than or equal to zero degrees Celsius and a change in tan delta of less than or equal to 35% from a median value measured over a temperature range of from about negative 20 degrees Celsius to about 60 degrees Celsius.

13. The vehicle of claim 12, wherein the vehicle seat cushion is positioned in a seat bottom of a vehicle seat and wherein the second foam is vertically oriented relative to the first foam.

14. The vehicle of claim 13, wherein the first foam is positioned in the seat cushion forward of a hip point.

15. The vehicle of claim 13, wherein the first foam increases in thickness in the seat cushion in a forward direction.

16. The vehicle of claim 13, wherein a top surface of the first foam inclines upwardly in a forward direction of the vehicle seat.

17. The vehicle of claim 13, wherein the first foam comprises a plurality of vertically oriented columns.

18. The vehicle of claim 17, wherein each of the plurality of vertically oriented columns is angled rearwardly in the upward direction.

19. The vehicle of claim 12, wherein the vehicle seat cushion is positioned in a seat back of a vehicle seat and wherein the second foam is longitudinally oriented relative to the first foam.

20. The vehicle of claim 19, wherein the first foam increases in thickness in the cushion in an upward direction.
